(19) United States
(12) Patent Application Publication
(10) Pub. No.: US 2026/0066398 A1
(43) Pub. Date: Mar. 5, 2026

(54) HIGH VOLTAGE COMPONENT PERIODIC CONDITIONING WAKEUP BASED ON REAL TIME WEATHER

(71) Applicant: FCA US LLC, Auburn Hills, MI (US)

(72) Inventor: Abhilash Gudapati, Auburn Hills, MI (US)

(21) Appl. No.: 18/817,881

(22) Filed: Aug. 28, 2024

(51) Int. Cl. H01M 16/00; B60L 58/32; B60L 58/40; H01M 8/0432; H01M 8/04701; H01M 10/42; H01M 10/48; H01M 10/625; H01M 10/635

(52) U.S. Cl. CPC H01M 16/006; B60L 58/32; B60L 58/40; H01M 8/0432; H01M 8/04701; H01M 10/425; H01M 10/486; H01M 10/625; H01M 10/635; H01M 2220/20; H01M 2250/20; H01M 2250/402

(57) ABSTRACT

A high voltage component temperature conditioning system for an electrified powertrain of an electrified vehicle includes a high voltage component, an ambient temperature sensor, a weather information controller, and a supervisory controller. The high voltage component generates a high voltage component status signal based on a status of the high voltage component. The ambient temperature sensor senses an ambient temperature and generates an ambient temperature signal indicative of the sensed ambient temperature. The weather information controller receives weather information and generates a weather signal indicative of the weather information. The supervisory controller: receives the ambient temperature signal and the weather signal; and calculates a next periodic wakeup timer based on the ambient temperature signal and the weather signal.

### FIELD

The present application generally relates to electrified vehicles and, more particularly, to a control system and method for conditioning the temperature of a battery pack of the electrified vehicle while the vehicle is in a key off state.

### BACKGROUND

An electrified vehicle (hybrid electric, plug-in hybrid electric, range-extended electric, battery electric, etc.) includes at least one battery system and at least one electronic drive module having an electric motor and associated electric drive gearbox assembly. Typically, the electrified vehicle would include a high voltage battery system and a low voltage (e.g., 12 volt) battery system. In such a configuration, the high voltage battery system is utilized to power at least one electric motor configured on the vehicle and to recharge the low voltage battery system via a direct current to direct current (DC-DC) convertor. In some instances when powering down the high voltage battery system after keying off the vehicle, the battery temperature can rise above or below respective threshold temperatures due to ambient temperature conditions. Battery power limits are determined based on the battery temperature. If the battery is cold then the power limits will be reduced. Similarly, if the battery is hot, then the power limited will be reduced and the battery lifespan (e.g., charging and discharging capabilities) can be affected. Some vehicle systems are configured to perform periodic wakeups to check battery temperatures and perform cooling or heating mitigation when temperatures are outside of acceptable thresholds. Sometimes preset wakeup intervals are insufficient to properly account for temperature changes. Further, unexpected weather changes may occur that drastically alter ambient temperatures from those measured at key off. Accordingly, while such high voltage conditioning systems do work well for their intended purpose in electrified vehicles, there is a desire for improvement in the relevant art.

### SUMMARY

According to one example aspect of the invention a high voltage component temperature conditioning system for an electrified powertrain of an electrified vehicle includes a high voltage component, an ambient temperature sensor, a weather information controller, and a supervisory controller. The high voltage component generates a high voltage component status signal (or signals) based on a status of the high voltage component. The ambient temperature sensor senses an ambient temperature and generates an ambient temperature signal indicative of the sensed ambient temperature. The weather information controller receives weather information and generates a weather signal indicative of the weather information. The supervisory controller: receives the ambient temperature signal and the weather signal; and calculates a next periodic wakeup timer based on the ambient temperature signal and the weather signal.

In some implementations, the supervisory controller receives the high voltage component status signal; and calculates the next periodic wakeup timer based on the ambient temperature signal, the weather signal and the high voltage component status signal.

In some implementations, the supervisory controller receives an ignition on timer signal indicative of an amount of ignition cycles within a calibration time (e.g., time the vehicle ignition has been switched to an ON state); and calculates the next periodic wakeup timer based on the ambient temperature signal, the weather signal, the high voltage component status signal, and the ignition on timer signal.

In some implementations, the high voltage component temperature conditioning system further comprises a high voltage component heating/cooling system, wherein the supervisory controller is further configured to: wake up the high voltage temperature conditioning system based on the wakeup timer; determine whether a corrective action is desired based on a temperature of the high voltage system; and communicate a signal to the high voltage component heating/cooling system to perform a corrective action based on a determination that a corrective action is needed.

In some implementations, the weather information receives the weather information in real-time wirelessly.

In additional aspects, the weather information controller includes a human machine interface (HMI).

In additional features, the weather information controller includes a telematics module.

In additional features, the high voltage component temperature conditioning system further includes a fuel cell system. The high voltage component status signal is further based on a status of the fuel cell system.

In additional features, the high voltage component is a high voltage battery system.

According to one example aspect of the invention, a method of operating a high voltage component temperature conditioning system for an electrified powertrain of an electrified vehicle is provided. The electrified powertrain includes a high voltage component that generates a high voltage component status signal based on a status of the high voltage component; an ambient temperature sensor that senses an ambient temperature and generates an ambient temperature signal indicative of the sensed ambient temperature; and a weather information controller that receives weather information and generates a weather signal indicative of the weather information. The method includes: receiving, at a supervisory controller, the ambient temperature signal and the weather signal; and calculating, at the supervisory controller, a next periodic wakeup timer based on the ambient temperature signal and the weather signal.

In additional features, the method further comprises: receiving, at the supervisory controller, the high voltage component status signal; and calculating, at the supervisory controller, the next periodic wakeup timer based on the ambient temperature signal, the weather signal and the high voltage component status signal.

In additional features, the method includes: receiving, at the supervisory controller, an ignition on timer signal indicative of an amount of ignition cycles within a calibration time (e.g., time the vehicle ignition has been switched to an ON state); and calculating, at the supervisory controller, the next periodic wakeup timer based on the ambient temperature signal, the weather signal, the high voltage component status signal, and the ignition on timer signal. The timer is used to ensure that the ambient temperature sensor stabilizes and sends accurate values.

In additional features, the electrified powertrain further includes a high voltage component heating/cooling system and the method further includes: waking up the high voltage temperature conditioning system based on the wakeup timer; determining, at the supervisory controller, whether a corrective action is desired based on a temperature of the high voltage system; and communicating, from the supervisory controller, a signal to the high voltage component heating/cooling system to perform a corrective action based on a determination that a corrective action is needed.

In additional features of the method, the weather information receives the weather information in real-time wirelessly.

In additional features of the method, the weather information controller includes a human machine interface (HMI).

In other features of the method, the weather information controller includes a telematics module.

In additional features of the method, the electrified powertrain further comprises a fuel cell system, wherein the high voltage component status signal is further based on a status of the fuel cell system.

In additional features of the method, the high voltage component is a high voltage battery system.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1 is a functional block diagram of an electrified vehicle that implements a battery pack temperature conditioning system according to various principles of the present application;

FIG. 2 is another functional block diagram of the battery pack temperature conditioning system of FIG. 1 illustrating a weather information controller of the human interface module according to additional features of the present application;

FIG. 3 is a functional block diagram of a periodic wakeup timer calculation module implemented by the controller of FIG. 1 according to one example of the present disclosure; and

FIGS. 4A-4B is a logic flow diagram illustrating an exemplary method of operating the battery pack temperature conditioning system of FIG. 1 according to various examples of the present disclosure.

### DESCRIPTION

As mentioned above, battery power limits are determined based on the battery temperature. If the battery is too hot or too cold then the power limits will be reduced. The battery lifespan can also be affected from repeated temperature swings. Some electrified vehicles are configured to perform periodic wakeups using a timer. During a periodic wakeup, when the vehicle is off, a controller checks battery temperatures and commands various components to perform cooling or heating mitigation when temperatures are outside of acceptable thresholds. Sometimes pre-set wakeup intervals are insufficient to properly account for temperature changes. Further, unexpected weather changes may occur that drastically alter ambient temperatures from those measured by vehicle temperature sensor(s) at key off. In yet other scenarios, the vehicle temperature sensor(s) may be inaccurate or measure a correct temperature, but not representative of the temperature the battery is experiencing.

The instant disclosure provides a battery pack temperature conditioning system that utilizes information from weather applications (through telematics interface, e.g., cloud) and/or through the human machine interface (HMI) to accurately predict the ambient temperature and the drift of temperature over time (hours, days, etc.). The timer is then adjusted based on this temperature prediction to more accurately and efficiently condition the high voltage component. The amount of inconsistent wake ups caused by solely relying on ambient temperature changes is reduced.

As will become appreciated from the following discussion, the battery pack temperature conditioning system addresses any potential ambient temperature sensor failure condition by leveraging weather information from the weather control unit or weather information controller. Robustness and capability increases to accurately predict temperature changes, its impact on the high voltage components. A periodic timer is created based on the additional weather information rather than simply basing it off of the current ambient temperature. The battery pack temperature conditioning system checks between the ambient temperature conditions and the weather conditions to produce a consistent and more representative timer. The battery pack temperature conditioning system can account for the vehicle being parked in a heated or cooled garage. The battery pack temperature conditioning system accounts for a condition where the ambient temperature is out of range from the existing weather conditions.

The system is further stabilized by considering the time that the vehicle has been switched on and rationalizing that with the weather information received. The new inputs, described herein, provide higher predictability, reduce the recurring wakeups for conditioning thereby improving the capability of the high voltage component conditioning only when needed and improving the overall life of the component.

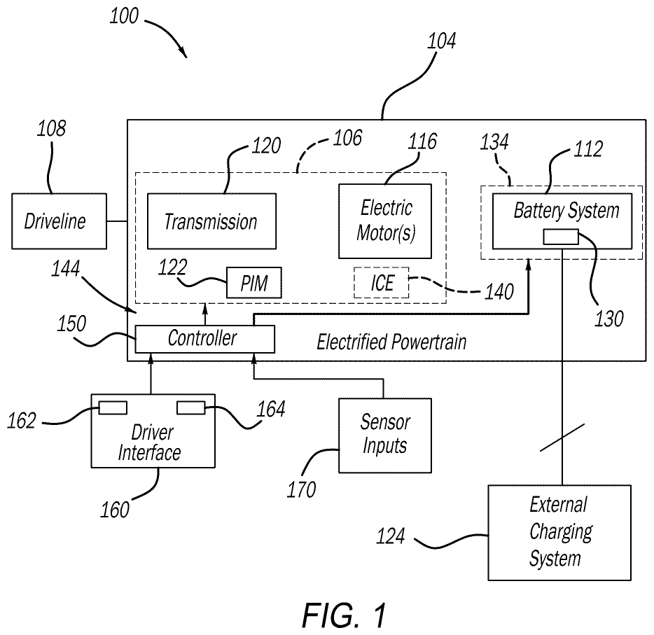

Referring now to FIG. 1, a functional block diagram of an example electrified vehicle 100 (also referred to herein as “vehicle 100”) according to the principles of the present application is illustrated. The vehicle 100 includes an electrified powertrain 104 having an electric drive module (EDM) 106 configured to generate and transfer drive torque to a driveline 108 for vehicle propulsion. The EDM 106 generally includes one or more electric drive units or motors 116 (e.g., electric traction motors), an electric drive gearbox assembly or transmission 120, and power electronics including a power inverter module (PIM) 122.

The electric motor 116 is selectively connectable via the PIM 122 to a high voltage component or battery system 112 for powering the electric motor 116. The battery system 112 is selectively connectable (e.g., by the driver) to an external charging system 124 (also referred to herein as “charger 124”) for charging of the battery system 112. The battery system 112 includes at least one battery pack assembly 130. The battery system 112 is heated and cooled by a battery heating and cooling system 134. The battery heating and cooling system 134 can include any system (air systems, and/or liquid systems) suitable to change the temperature of the battery system 112. In some examples, described herein, the electrified powertrain 104 can be a hybrid powertrain that additionally includes an internal combustion engine 140. In other examples, the electrified powertrain 104 can additionally or alternatively comprise a fuel cell system.

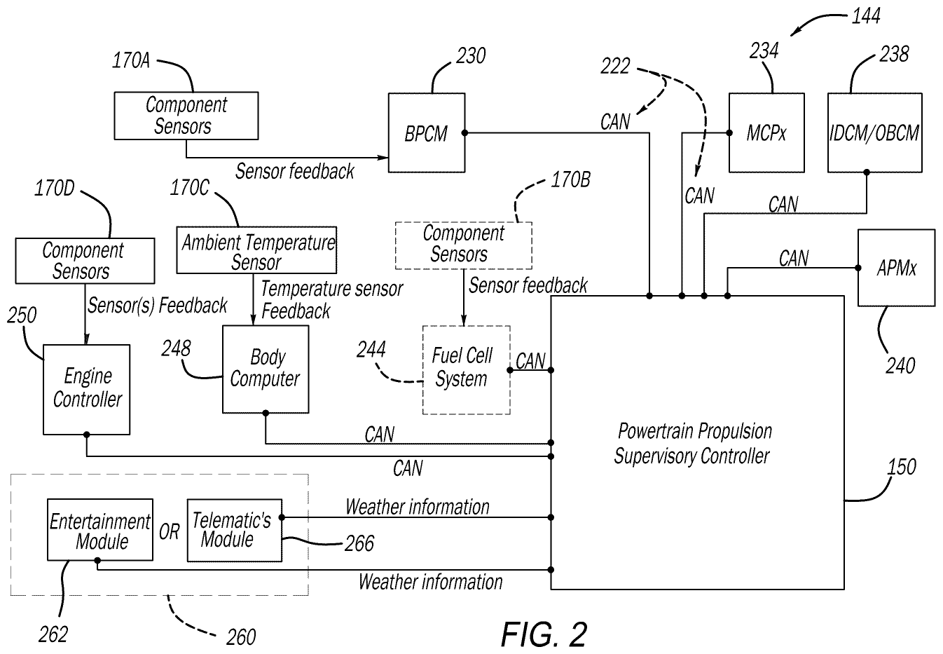

A high voltage component temperature conditioning system 144 includes a controller 150 that can provide various inputs to the EDM 106 and to the battery heating and cooling system 134. The high voltage component temperature conditioning system 144 is also referred to herein as a battery pack temperature conditioning system. Inputs to the EDM 106 can include torque requests based on signals received from a driver interface 160. In examples, the driver interface 160 can include a drive input device, e.g., an accelerator pedal 162, for providing a driver input, e.g., a torque request, to the controller 150 and ultimately the EDM 106. The driver interface 160 can further include a human machine interface (HMI) 164 for communicating weather information obtained by a weather information controller 260 (FIG. 2) as will be described herein. In some examples, the HMI 164 can be arranged on an instrument cluster, a dash board and/or a steering wheel of the electrified vehicle 100. The controller 150 is configured to set a timer for periodic high voltage component conditioning and power down based on the weather information obtained by the weather information controller 260.

With additional reference now to FIG. 2, additional features of the battery pack temperature conditioning system 144 of FIG. 1 will be described. The controller 150 shown in FIG. 1 is represented as a powertrain supervisory controller in FIG. 2. It will be appreciated however that the controller 150 can comprises additional or alternative controllers and modules such as, but not limited to, a battery control module, a motor control module, a heating, cooling and ventilation (HVAC) controller and other modules that can communicate with various vehicle components of the electrified vehicle 100. In this regard, various controllers and modules are configured to communicate with each other, utilizing different sensor inputs 170 and calculated parameters as disclosed herein for controlling operation of the battery pack temperature conditioning system 144.

One or more controllers are utilized to control the various vehicle components or system discussed above. In one exemplary implementation, various individual controllers are utilized to control the various components/systems discussed herein and are in communication with each other and/or the various components/systems via a local interface 222. In this exemplary implementation, the local interface 222 is one or more buses or other wired or wireless connections, as is known in the art. In the example illustrated in FIG. 2, the local interface 222 is a controller area network (CAN). The CAN 222 may include additional elements or features, which have been omitted for simplicity, such as controllers, buffers (cache) drivers, repeaters and receivers, among many others, to enable communications. Further, the CAN 222 may include address, control and/or data connections to enable appropriate communications among the components/systems described herein.

A battery pack control module 230 receives sensor feedback from component sensors 170A and communicates information over the CAN 222 related to the battery system 112 to the controller 150. A motor controller processor (MCPx) 234 communicates information over the CAN 222 to the controller 150. The MCPx can provide torque as requested. An integrated dual charging module or on board charging module (IDCM/OBCM) 238 communicates information related to the charging components over the CAN 222 to the controller 150. An auxiliary power module (DC-DC converter, APMx) 240 communicates information over the CAN 222 to the controller 150. The APMx can charge the low voltage system. An engine controller 250 receives sensor feedback from component sensors 170B and communicates information over the CAN 222 to the supervisory controller 150. A body computer 248 receives temperature sensor feedback from an ambient temperature sensor 170C and communicates temperature information over the CAN 222 to the controller 150. For a fuel cell configured vehicle, a fuel cell system 244 receives sensor feedback from component sensors 170B and communicates information related to the fuel cell system 244 over the CAN to the controller 150.

The weather information controller 260 includes an entertainment module 262 and/or a telematics module 266. The weather information controller 260 receives weather information, such as wirelessly over the air, and communicates the weather information to the controller 150. One or both of the entertainment module 262 and the telematics module 266 can be integrated with the HMI 164.

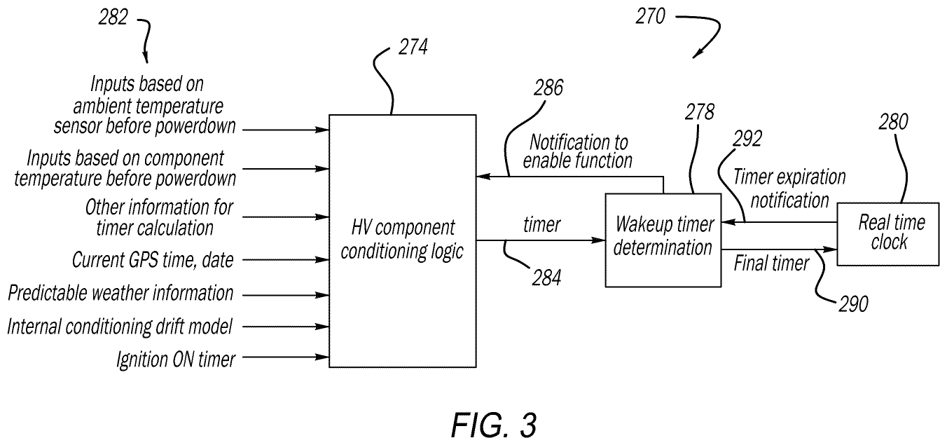

With additional reference now to FIG. 3, a functional block diagram of a periodic wakeup timer calculation module 270 implemented by the controller 150 will be described. The periodic wakeup timer calculation module 270 generally includes a high voltage conditioning logic module 274, a wakeup timer determination module 278 and a real time clock module 280. The high voltage conditioning logic module 274 receives inputs collectively identified at 282. The inputs include, but are not limited to, inputs based on ambient temperature sensor 170C before power down, inputs based on component temperature before power down, other information for timer calculation, current global positioning system (GPS) time, date, predictable weather information, internal conditioning drift model and ignition ON timer.

The high voltage conditioning logic module 274 outputs a timer signal 284 to the wakeup timer determination module 278 based on the inputs 282. The wakeup timer determination module sends a notification signal 286 to enable the function back to the high voltage conditioning logic module 274. The wakeup timer determination module 278 determines and communicates a final timer signal 290 to the real time clock module 280. The real time clock module 280 implements the new time to wake up. The real time clock module 280 returns a timer expiration notification signal 292 to the wakeup timer determination module 278.

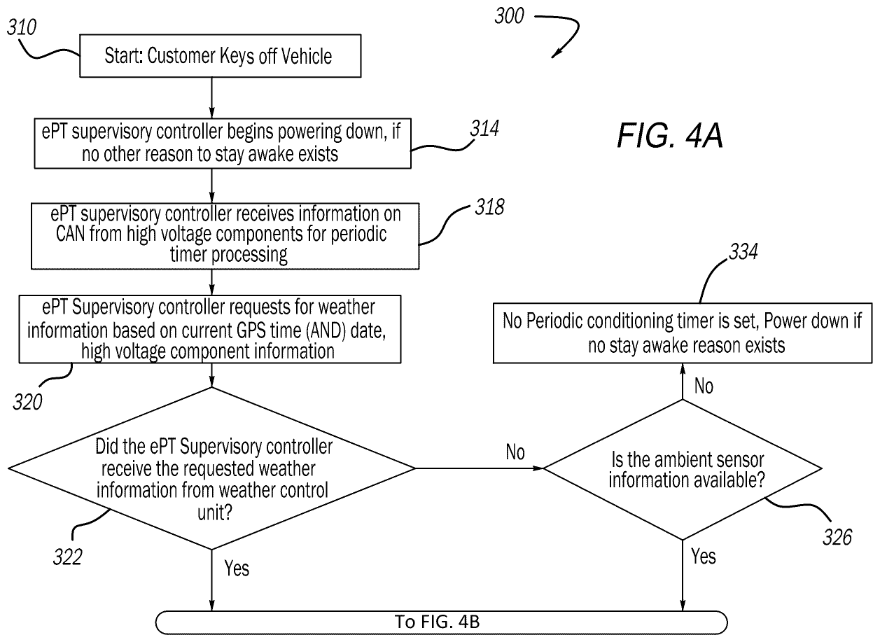

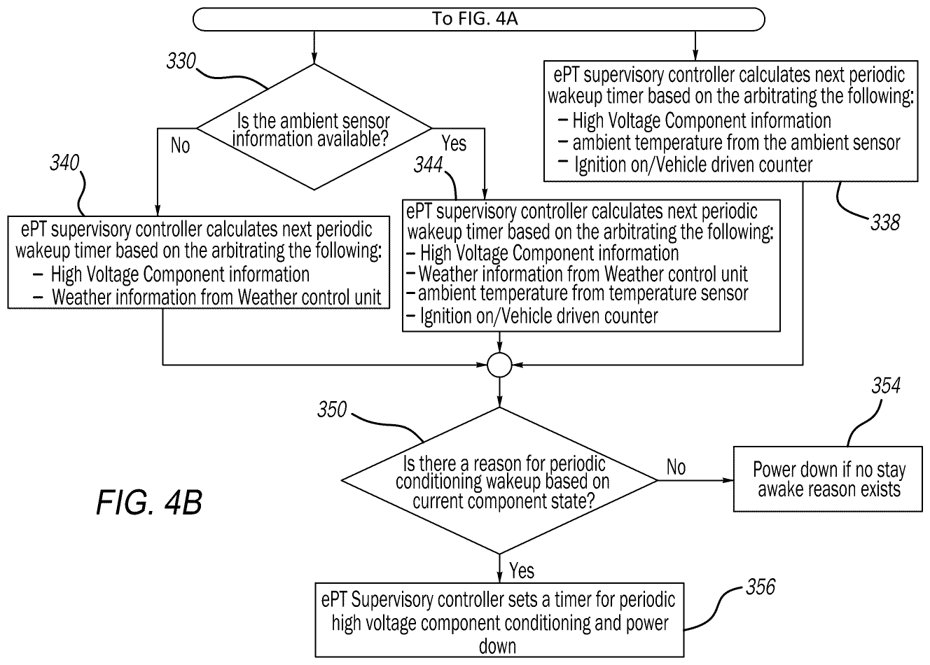

With additional reference now to FIGS. 4A and 4B, an exemplary method 300 of operating the battery pack temperature conditioning system 144 of FIG. 1 will be described. At 310, control starts when the customer keys off the vehicle 100. At 314, the controller 150 begins powering down if no other reason to stay awake exists. At 318, the controller 150 receives information over the CAN 222 from high voltage components. As used herein, a high voltage component status signal can be referred to as including collective signals such as temperature information from the temperature sensor 170C related to the battery system 112 and/or fuel cell system 244, and other data received over the CAN 222 described herein, for periodic timer processing. At 320, the controller 150 requests for weather information based on current GPS time and date and high voltage component information. At 322, the controller determines if the requested weather information has been received from the weather information controller 260. In examples, the weather information controller 260 provides information in hours and temperature through an encoded signal to the controller 150.

If control determines that the requested weather information has not been received at 322, the controller 150 determines whether the ambient temperature information is available from the ambient temperature sensor 170C at 326. If not, no periodic conditioning timer is set and power down proceeds if no stay awake reason exists at 344. If control determines that the requested weather information has been received at 322, control determines whether the ambient temperature information is available from the ambient temperature sensor 170C at 330. If control determines that the ambient temperature information is not available from the ambient temperature sensor 170C at 330, control calculates a next periodic wakeup timer based on arbitrating: (i) the high voltage component information and (ii) the weather information from the weather information controller 260 at 340. If control determines that the ambient temperature information is available from the ambient temperature sensor 170C at 330, control calculates a next periodic wakeup timer based on arbitrating: (i) the high voltage component information; (ii) the weather information from the weather information controller 260; (iii) ambient temperature from the temperature sensor 170C; and (iv) ignition on/vehicle driven counter at 344.

If control determines that the ambient temperature information is available from the ambient temperature sensor 170C at 326, control calculates a next periodic wakeup timer based on arbitrating: (i) the high voltage component information; (ii) ambient temperature from the temperature sensor 170C; and (iii) ignition on/vehicle driven counter.

At 350, control determines if there is a reason for periodic conditioning wakeup based on current component state 350. If control determines that there is no reason for periodic conditioning at 350, control powers down if no stay away condition exists at 354. If control determines that there is a reason for periodic conditioning at 350 sets a timer for periodic high voltage component conditioning and power down at 356. In examples, the controller 150 can command the battery heating/cooling system 134 to perform a corrective action (e.g., heat or cool the high voltage components including the battery system 112) subsequent to a wakeup and determination that a corrective action is desired.

In examples, due to the availability of the ambient temperatures sensor 170C and the weather information from the weather control unit 260, the controller 150 will differentiate if the vehicle 100 is located in a heated or cooled garage based on the timer that the vehicle was driven, change in ambient temperature (if it changed after key off), and the weather information comparison to determine an optimal timer again. In this regard, the controller 150 may determine that the temperature characteristics may change over a determined number of days. The battery pack temperature conditioning system 144 can also take into account an amount of time that the vehicle 100 has been in ignition on (this can include vehicle driven for calibratable time to ensure the accuracy of the stabilization) to ensure and understand that the ambient temperature is stabilized before coming up with a predicable timer.

As used herein, the term controller or module refers to an application specific integrated circuit (ASIC), an electronic circuit, a processor (shared, dedicated, or group) and memory that executes one or more software or firmware programs, a combinational logic circuit, and/or other suitable components that provide the described functionality.

It will be understood that the mixing and matching of features, elements, methodologies, systems and/or functions between various examples may be expressly contemplated herein so that one skilled in the art will appreciate from the present teachings that features, elements, systems and/or functions of one example may be incorporated into another example as appropriate, unless described otherwise above. It will also be understood that the description, including disclosed examples and drawings, is merely exemplary in nature intended for purposes of illustration only and is not intended to limit the scope of the present application, its application or uses. Thus, variations that do not depart from the gist of the present application are intended to be within the scope of the present application.

What is claimed is:

1. A high voltage component temperature conditioning system for an electrified powertrain of an electrified vehicle, the high voltage component temperature conditioning system comprising:
a high voltage component that generates a high voltage component status signal based on a status of the high voltage component;
an ambient temperature sensor that senses an ambient temperature and generates an ambient temperature signal indicative of the sensed ambient temperature;
a weather information controller that receives weather information and generates a weather signal indicative of the weather information;
a supervisory controller that:
receives the ambient temperature signal and the weather signal; and
calculates a next periodic wakeup timer based on the ambient temperature signal and the weather signal.

2. The high voltage component temperature conditioning system of claim 1, wherein the supervisory controller further:
receives the high voltage component status signal; and
calculates the next periodic wakeup timer based on the ambient temperature signal, the weather signal and the high voltage component status signal.

3. The high voltage component temperature conditioning system of claim 2, wherein the supervisory controller further:
receives an ignition on timer signal indicative of an amount of ignition cycles within a calibration time; and
calculates the next periodic wakeup timer based on the ambient temperature signal, the weather signal, the high voltage component status signal, and the ignition on timer signal.

4. The high voltage component temperature conditioning system of claim 1, further comprising:
a high voltage component heating/cooling system, wherein the supervisory controller is further configured to:
wake up the high voltage temperature conditioning system based on the wakeup timer;
determine whether a corrective action is desired based on a temperature of the high voltage system; and
communicate a signal to the high voltage component heating/cooling system to perform a corrective action based on a determination that a corrective action is needed.

5. The high voltage component temperature conditioning system of claim 1, wherein the weather information receives the weather information in real-time wirelessly.

6. The high voltage component temperature conditioning system of claim 1, wherein the weather information controller includes a human machine interface (HMI).

7. The high voltage component temperature conditioning system of claim 1, wherein the weather information controller includes a telematics module.

8. The high voltage component temperature conditioning system of claim 2, further comprising:
a fuel cell system, wherein the high voltage component status signal is further based on a status of the fuel cell system.

9. The high voltage component temperature conditioning system of claim 1, wherein the high voltage component is one of a high voltage battery system and a fuel cell system.

10. A method of operating a high voltage component temperature conditioning system for an electrified powertrain of an electrified vehicle, the electrified powertrain including a high voltage component that generates a high voltage component status signal based on a status of the high voltage component; an ambient temperature sensor that senses an ambient temperature and generates an ambient temperature signal indicative of the sensed ambient temperature; and a weather information controller that receives weather information and generates a weather signal indicative of the weather information, the method comprising:
receiving, at a supervisory controller, the ambient temperature signal and the weather signal; and
calculating, at the supervisory controller, a next periodic wakeup timer based on the ambient temperature signal and the weather signal.

11. The method of claim 10, further comprising:
receiving, at the supervisory controller, the high voltage component status signal; and
calculating, at the supervisory controller, the next periodic wakeup timer based on the ambient temperature signal, the weather signal and the high voltage component status signal.

12. The method of claim 11, further comprising:
receiving, at the supervisory controller, an ignition on timer signal indicative of an amount of ignition cycles within a calibration time; and
calculating, at the supervisory controller, the next periodic wakeup timer based on the ambient temperature signal, the weather signal, the high voltage component status signal, and the ignition on timer signal.

13. The method of claim 10, wherein the electrified powertrain further includes a high voltage component heating/cooling system, the method further comprising:
waking up the high voltage temperature conditioning system based on the wakeup timer;
determining, at the supervisory controller, whether a corrective action is desired based on a temperature of the high voltage system; and
communicating, from the supervisory controller, a signal to the high voltage component heating/cooling system to perform a corrective action based on a determination that a corrective action is needed.

14. The method of claim 10, wherein the weather information receives the weather information in real-time wirelessly.

15. The method of claim 10, wherein the weather information controller includes a human machine interface (HMI).

16. The method of claim 10, wherein the weather information controller includes a telematics module.

17. The method of claim 11, wherein the electrified powertrain further comprises a fuel cell system, wherein the high voltage component status signal is further based on a status of the fuel cell system.

18. The method of claim 10, wherein the high voltage component is a high voltage battery system.
